(19) United States
(12) Patent Application Publication
(10) Pub. No.: US 2019/0090278 A1
(43) Pub. Date: Mar. 21, 2019

(54) Clear Channel Assessment for Duplex Transmissions in Wireless Local Area Networks

(71) Applicant: Marvell World Trade Ltd., St. Michael (BB)

(72) Inventors: Liwen CHU, San Ramon, CA (US); Hongyuan ZHANG, Fremont, CA (US); Hui-Ling LOU, Sunnyvale, CA (US)

(21) Appl. No.: 16/131,789

(22) Filed: Sep. 14, 2018

Related U.S. Application Data
(60) Provisional application No. 62/559,370, filed on Sep. 15, 2017.

(51) Int. Cl. H04W 74/08; H04L 5/14

(52) U.S. Cl. CPC H04W 74/0816; H04W 84/12; H04L 5/143

(57) ABSTRACT

A first communication device receives a first packet from a second communication device. The first packet is addressed to the first communication device, and the first packet spans a communication channel. The first communication device and the second communication device belong to a communication network. The first communication device determines whether another communication network is also using the communication channel during the transmission of the first packet. In response to determining that another communication network is not using the communication channel during the transmission of the first packet, the first communication device transmits, in the communication channel, a second packet addressed to the second communication device while the first communication device is receiving the first packet.

### CROSS REFERENCES TO RELATED APPLICATIONS

This application claims the benefit of U.S. Provisional Patent Application No. 62/559,370, entitled “Clear Channel Assessment for Duplex MAC,” filed on Sep. 15, 2017, the disclosure of which is hereby expressly incorporated herein by reference in its entirety.

### FIELD OF TECHNOLOGY

The present disclosure relates generally to wireless communication systems, and more particularly to full-duplex transmissions in a wireless local area network (WLAN).

### BACKGROUND

Wireless local area networks (WLANs) have evolved rapidly over the past decade, and development of WLAN standards such as the Institute for Electrical and Electronics Engineers (IEEE) 802.11 Standard family has improved single-user peak data throughput. For example, the IEEE 802.11b Standard specifies a single-user peak throughput of 11 megabits per second (Mbps), the IEEE 802.11a and 802.11g Standards specify a single-user peak throughput of 54 Mbps, the IEEE 802.11n Standard specifies a single-user peak throughput of 600 Mbps, and the IEEE 802.11ac Standard specifies a single-user peak throughput in the gigabits per second (Gbps) range. Future standards promise to provide even greater throughput, such as throughputs in the tens of Gbps range.

Traditional WLAN devices are not configured to transmit and receive simultaneously within the same communication channel because the transmission will cause “self-interference” with the reception. However, self-interference cancellation techniques now allow permit simultaneous wireless transmission and reception within the same communication channel.

### SUMMARY

In an embodiment, a method includes: receiving, at a first communication device, a first packet from a second communication device, wherein: the first packet is addressed to the first communication device, the first communication device and the second communication device belong to a communication network, and the first packet spans a communication channel. The method also includes: determining, at the first communication device, whether another communication network is also using the communication channel during the transmission of the first packet; and in response to determining that another communication network is not using the communication channel during the transmission of the first packet, transmitting, by the first communication device, a second packet addressed to the second communication device, wherein the second packet is transmitted while the first communication device is receiving the first packet, and wherein the second packet is transmitted in the communication channel.

In another embodiment, an apparatus comprises: a network interface device associated with a first communication device, wherein the network interface device includes one or more integrated circuit (IC) devices. The one or more IC devices are configured to: receive a first packet from a second communication device, wherein: the first packet is addressed to the first communication device, the first communication device and the second communication device belong to a communication network, and the first packet spans a communication channel. The one or more IC devices are further configured to: determine whether another communication network is also using the communication channel during the transmission of the first packet; and in response to determining that another communication network is not using the communication channel during the transmission of the first packet, transmit a second packet addressed to the second communication device, wherein the second packet is transmitted while the first communication, device is receiving the first packet, and wherein the second packet is transmitted in the communication channel.

### BRIEF DESCRIPTION OF THE DRAWINGS

FIG. 1 is a block diagram of an example wireless local area network (WLAN), according to an embodiment.

FIG. 2A is a diagram of a spatial arrangement of an example WLAN, according to an embodiment.

FIG. 2B is a timing diagram of an example half-duplex communication exchange in the WLAN of FIG. 2A.

FIG. 2C is a timing diagram of an example duplex communication exchange in the WLAN of FIG. 2A, according to an embodiment.

FIG. 3A is a diagram of a spatial arrangement of an example communication system, according to an embodiment.

FIG. 3B is a timing diagram of an example duplex communication exchange in the communication system of FIG. 3A, according to an embodiment.

FIG. 3C is a timing diagram of an example communication exchange in the communication system of FIG. 3A, according to an embodiment.

FIG. 3D is a timing diagram of another example duplex communication exchange in the communication system of FIG. 3A, according to an embodiment.

FIG. 4 is a timing diagram of another example duplex communication exchange in the communication system of FIG. 3A, according to an embodiment.

FIG. 5 is a flow diagram of an example method for participating in a duplex, transmission, according to an embodiment.

### DETAILED DESCRIPTION

Clear channel assessment (CCA) techniques described below are discussed in the context of wireless local area networks (WLANs) that utilize protocols the same as or similar to protocols defined by the 802.11 Standard from the Institute of Electrical and Electronics Engineers (IEEE) merely for explanatory purposes. In other embodiments, however, CCA techniques such as described herein are utilized in other types of wireless communication systems such as personal area networks (PANs), mobile communication networks such as cellular networks, metropolitan area networks (MANs), satellite communication, networks, etc.

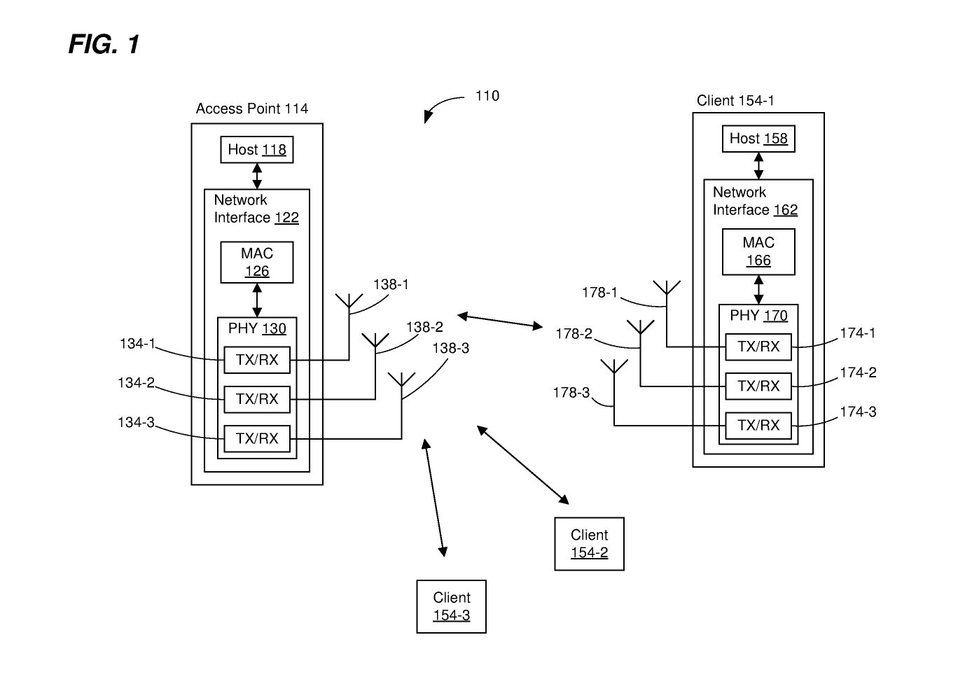

FIG. 1 is a block diagram of an example wireless local area network (WLAN) 110, according to an embodiment. The WLAN 110 includes an access point (AP) 114 that comprises a host processor 118 coupled to a network interface device 122. The network interface 122 includes a medium access control (MAC) processor 126 and a physical layer (PHY) processor 130. The PHY processor 130 includes a plurality of transceivers 134, and the transceivers 134 are coupled to a plurality of antennas 138. Although three transceivers 134 and three antennas 138 are illustrated in FIG. 1, the AP 114 includes other suitable numbers (e.g., 1, 2, 4, 5, etc.) of transceivers 134 and antennas 138 in other embodiments. In some embodiments, the AP 114 includes a higher number of antennas 138 than transceivers 134, and antenna switching techniques are utilized.

The network interface 122 is implemented using one or more integrate circuits (ICs) configured to operate as discussed below. For example, the MAC processor 126 may be implemented, at least partially, on a first IC, and the PHY processor 130 may be implemented, at least partially, on a second IC. As another example, at least a portion of the MAC processor 126 and at least a portion of the PHY processor 130 may be implemented on a single IC. For instance, the network interface 122 may be implemented using a system on a chip (SoC), where the SoC includes at least a portion of the MAC processor 126 and at least a portion of the PHY processor 130.

In an embodiment, the host processor 118 includes a processor configured to execute machine readable instructions stored in a memory device (not shown) such as a random access memory (RAM), a read-only memory (ROM), a flash memory, etc. In an embodiment, the host processor 118 may be implemented, at least partially, on a first IC, and the network device 122 may be implemented, at least partially, on a second IC. As another example, the host processor 118 and at least a portion, of the network interface 122 may be implemented on a single IC.

In various embodiments, the MAC processor 126 and/or the PHY processor 130 of the AP 114 are configured to generate data units, and process received data units, that conform to a WLAN communication protocol such as a communication protocol conforming to the IEEE 802.11 Standard or another suitable wireless communication protocol. For example, the MAC processor 126 may be configured to implement MAC layer functions, including MAC layer functions of the WLAN communication protocol, and the PHY processor 130 may be configured to implement PHY functions, including PHY functions of the WLAN communication protocol. For instance, the MAC processor 126 may be configured to generate MAC layer data units such as MAC service data units (MSDUs), MAC protocol data units (MPDUs), etc., and provide the MAC layer data units to the PHY processor 130. The PHY processor 130 may be configured to receive MAC layer data units from the MAC processor 126 and encapsulate the MAC layer data units to generate PHY data units such as PHY protocol data units (PPDUs) for transmission via the antennas 138. Similarly, the PHY processor 130 may be configured to receive PHY data units that were received via the antennas 138, and extract MAC layer data units encapsulated within the PHY data units. The PHY processor 130 may provide the extracted MAC layer data units to the MAC processor 126, which processes the MAC layer data units.

In connection with generating one or more radio frequency (RF) signals for transmission, the PHY processor 130 is configured to process (which may include modulating, filtering, etc.) data corresponding to a PPDU to generate one or more digital baseband signals, and convert the digital baseband signal(s) to one or more analog baseband signals, according to an embodiment. Additionally, the PHY processor 130 is configured to upconvert the one or more analog baseband signals to one or more RF signals for transmission via the one or more antennas 138.

In connection with receiving one or more signals RF signals, the PHY processor 130 is configured to downconvert the one or more RF signals to one or more analog baseband signals, and to convert the one or more analog baseband signals to one or more digital baseband signals. The PHY processor 130 is further configured to process (which may include demodulating, filtering, etc.) the one or more digital baseband signals to generate a PPDU.

The PHY processor 130 includes amplifiers (e.g., a low noise amplifier (INA), a power amplifier, etc.), a radio frequency (RF) downconverter, an RF upconverter, a plurality of filters, one or more analog-to-digital converters (ADCs), one or more digital-to-analog converters (DACs), one or more discrete Fourier transform (DFT) calculators (e.g., a fast Fourier transform (FFT) calculator), one or more inverse discrete Fourier transform (IDFT) calculators (e.g., an inverse fast Fourier transform (IFFT) calculator), one or more modulators, one or more demodulators, etc.

The PHY processor 130 is configured to generate one or more RF signals that are provided to the one or more antennas 138. The PHY processor 130 is also configured to receive one or more RF signals from the one or more antennas 138.

The MAC processor 126 is configured to control the PHY processor 130 to generate one or more RF signals by, for example, providing one or more MAC layer data units (e.g., MPDUs) to the PHY processor 130, and optionally providing one or more control signals to the PHY processor 130, according to some embodiments. In an embodiment, the MAC processor 126 includes a processor configured to execute machine readable instructions stored in a memory device (not shown) such as a RAM, a ROM, a flash memory, etc. In an embodiment, the MAC processor 126 includes a hardware state machine.

In an embodiment, the network interface 122 is configured for in-band duplex communications. For example, in an embodiment, the access point 114 includes different antennas 138 (e.g., one or more transmit antennas 138, and one or more receive antennas 138) for transmission and reception, and the network interface 122 includes separate ports for electrically coupling to the one or more transmit antennas 138, and one or more receive antennas 138. In some embodiments, pathloss between transmit antennas 138 and receive antennas 138 can be increased by spacing the transmit/receive antennas apart and/or by utilizing absorptive shielding between transmit antennas 138 and receive antennas 138. In some embodiments, polarized antennas 138 are utilized, where the transmit antennas 138 and the receive antennas 138 are differently polarized. For example, transmit antennas 138 are configured to transmit only horizontally polarized signals, whereas receive antennas 138 are configured to receive only vertically polarized signals. In some embodiments, directional antennas 138 are utilized. For example, the directional antennas 138 are positioned such that receive antennas 138 are in null directions of the transmit antennas, and vice versa. In another embodiment, omnidirectional antennas 138 are placed to reduce self-interference. For example, omnidirectional antennas 138 are placed such that an omnidirectional receive antenna. 138 is at a location at which carrier waveforms from two omni-directional transmit antennas 138 are 180 degrees out of phase. In some embodiments, multiple input, multiple output (MIMO) beamforming techniques are utilized to reduce self-interference. For example, transmit and receive signals are beamformed in different directions to reduce self-interference.

In some embodiments, dual transmit/receive antennas 138 are utilized, and analog RF circuitry in the PHY processor 130 includes a duplexes, such as a circulator, configured to route transmit signals from a transmitter to the antenna and to route signals received on the antenna to a receiver, all while isolating a receiver-chain from a transmit-chain.

In some embodiments, the PHY processor 130 includes analog circuitry configured to cancel, from receive signals, transmit signals. For example, an analog circuit is configured to tap an RF transmit signal being provided to an antenna port, electronically process the tapped signal, and subtract from an RF receive signal in order to reduce self-interference. In some embodiments, the analog circuitry is also configured to cancel, from receive signals, reflections (multipath signals) of a transmit signal.

In some embodiments, the PHY processor 130 is configured to utilize digital signal processing (DSP) to cancel, from receive signals, transmit signals. For example, the PHY processor 130 includes a DSP processor (configured to execute machine readable instructions stored in a memory (not shown)) and/or DSP circuitry to cancel transmit signals from receive signals at baseband.

The WLAN 110 includes a plurality of client stations 154. Although three client stations 154 are illustrated in FIG. 1, the WLAN 110 includes other suitable numbers (e.g., 1, 2, 4, 5, 6, etc.) of client stations 154 in various embodiments. The client station 154-1 includes a host processor 158 coupled to a network interface device 162. The network interface 162 includes a MAC processor 166 and a PHY processor 170. The PHY processor 170 includes a plurality of transceivers 174, and the transceivers 174 are coupled to a plurality of antennas 178. Although three transceivers 174 and three antennas 178 are illustrated in FIG. 1, the client station 154-1 includes other suitable numbers (e.g., 1, 2, 4, 5, etc.) of transceivers 174 and antennas 178 in other embodiments. In some embodiments, the client station 154-1 includes a higher number of antennas 178 than transceivers 174, and antenna switching techniques are utilized.

The network interface 162 is implemented using one or more ICs configured to operate as discussed below. For example, the MAC processor 166 may be implemented on at least a first IC, and the PHY processor 170 may be implemented on at least a second IC. As another example, at least a portion of the MAC processor 166 and at least a portion of the PHY processor 170 may be implemented on a single IC. For instance, the network interface 162 may be implemented using an SoC, where the SoC includes at least a portion of the MAC processor 166 and at least a portion of the PHY processor 170.

In an embodiment, the host processor 158 includes a processor configured to execute machine readable instructions stored in a memory device (not shown) such as a RAM, a ROM, a flash memory, etc. In an embodiment, the host processor 158 may be implemented, at least partially, on a first IC, and the network device 162 may be implemented, at least partially, on a second IC. As another example, the host processor 158 and at least a portion of the network interface 162 may be implemented on a single IC.

In various embodiments, the MAC processor 166 and the PHY processor 170 of the client device 154-1 are configured to generate data units, and process received data units, that conform to the WLAN communication protocol or another suitable communication protocol. For example, the MAC processor 166 may be configured to implement MAC layer functions, including MAC layer functions of the WLAN communication protocol, and the PHY processor 170 may be configured to implement PHY functions, including PHY functions of the MILAN communication protocol. The MAC processor 166 may be configured to generate MAC layer data units such as MSDUs, MPDUs, etc., and provide the MAC layer data units to the PHY processor 170. The PHY processor 170 may be configured to receive MAC layer data units from the MAC processor 166 and encapsulate the MAC layer data units to generate PHY data units such as PPDUs for transmission via the antennas 178. Similarly, the PHY processor 170 may be configured to receive PHY data units that were received via the antennas 178, and extract MAC layer data units encapsulated within the PHY data units. The PHY processor 170 may provide the extracted MAC layer data units to the MAC processor 166, which processes the MAC layer data units.

The PHY processor 170 is configured to downconvert one or more RF signals received via the one or more antennas 178 to one or more baseband analog signals, and convert the analog baseband signal(s) to one or more digital baseband signals, according to an embodiment. The PHY processor 170 is further configured to process the one or more digital baseband signals to demodulate the one or more digital baseband signals and to generate a PPDU. The PHY processor 170 includes amplifiers (e.g., an LNA, a power amplifier, etc.), an RF downconverter, an RF upconverter, a plurality of filters, one or more ADCs, one or more DACs, one or more DFT calculators (e.g., an FFT calculator), one or more IDFT calculators (e.g., an IFFT calculator), one or more modulators, one or more demodulators, etc.

The PHY processor 170 is configured to generate one or more RF signals that are provided to the one or more antennas 178. The PHY processor 170 is also configured to receive one or more RF signals from the one or more antennas 178.

The MAC processor 166 is configured to control the PHY processor 170 to generate one or more RF signals by, for example, providing one or more MAC layer data, units (e.g., MPDUs) to the PHY processor 170, and optionally providing one or more control signals to the PHY processor 170, according to some embodiments. In an embodiment, the MAC processor 166 includes a processor configured to execute machine readable instructions stored in a memory device (not shown) such as a RAM, a ROM, a flash memory, etc. In an embodiment, the MAC processor 166 includes a hardware state machine.

In an embodiment, the network interface 162 is configured for in-band duplex communications. For example, in an embodiment, the client station 1544 includes different antennas 178 (e.g., one or more transmit antennas 178, and one or more receive antennas 178) for transmission and reception, and the network interface 162 includes separate ports for electrically coupling to the one or more transmit antennas 178, and one or more receive antennas 178. In some embodiments, pathloss between transmit antennas 178 and receive antennas 178 can be increased by spacing the transmit/receive antennas apart and/or by utilizing absorptive shielding between transmit antennas 178 and receive antennas 178. In some embodiments, polarized antennas 178 are utilized, where the transmit antennas 178 and the receive antennas 178 are differently polarized. For example, transmit antennas 178 are configured to transmit only horizontally polarized signals, whereas receive antennas 178 are configured to receive only vertically polarized signals. In some embodiments, directional antennas 178 are utilized. For example, the directional antennas 178 are positioned such that receive antennas 178 are in null directions of the transmit antennas, and vice versa. In another embodiment, omnidirectional antennas 178 are placed to reduce self-interference. For example, omnidirectional antennas 178 are placed such that an omnidirectional receive antenna 178 is at a location at which carrier waveforms from two omni-directional transmit antennas 178 are 180 degrees out of phase. In some embodiments, MIMO beamforming techniques are utilized to reduce self-interference. For example, transmit and receive signals are beamformed in different directions to reduce self-interference.

In some embodiments, dual transmit/receive antennas 178 are utilized, and analog RF circuitry in the PHY processor 170 includes a duplexer, such as a circulator, configured to route transmit signals from a transmitter to the antenna and to route signals received on the antenna to a receiver, all while isolating a receiver-chain from a transmit-chain.

In some embodiments, the PHY processor 170 includes analog circuitry configured to cancel, from receive signals, transmit signals. For example, an analog circuit is configured to tap an RF transmit signal being provided to an antenna port, electronically process the tapped signal, and subtract from an RF receive signal in order to reduce self-interference. In some embodiments, the analog circuitry is also configured to cancel, from receive signals, reflections (multipath signals) of a transmit signal.

In some embodiments, the PHY processor 170 is configured to utilize DSP to cancel, from receive signals, transmit signals. For example, the PHY processor 170 includes a DSP processor (configured to execute machine readable instructions stored in a memory (not shown)) and/or DSP circuitry to cancel transmit signals from receive signals at baseband.

In an embodiment, each of the client stations 154-2 and 154-3 has a structure that is the same as or similar to the client station 154-1. Each of the client stations 154-2 and 154-3 has the same or a different number of transceivers and antennas. For example, the client station 154-2 and/or the client station 154-3 each have only two transceivers and two antennas (not shown), according to an embodiment.

In some embodiments, one or both of the client stations 154-2 and 154-3 is configured for in-band duplex communication. In some embodiments, one or both of the client stations 154-2 and 154-3 is not configured for in-band duplex communication.

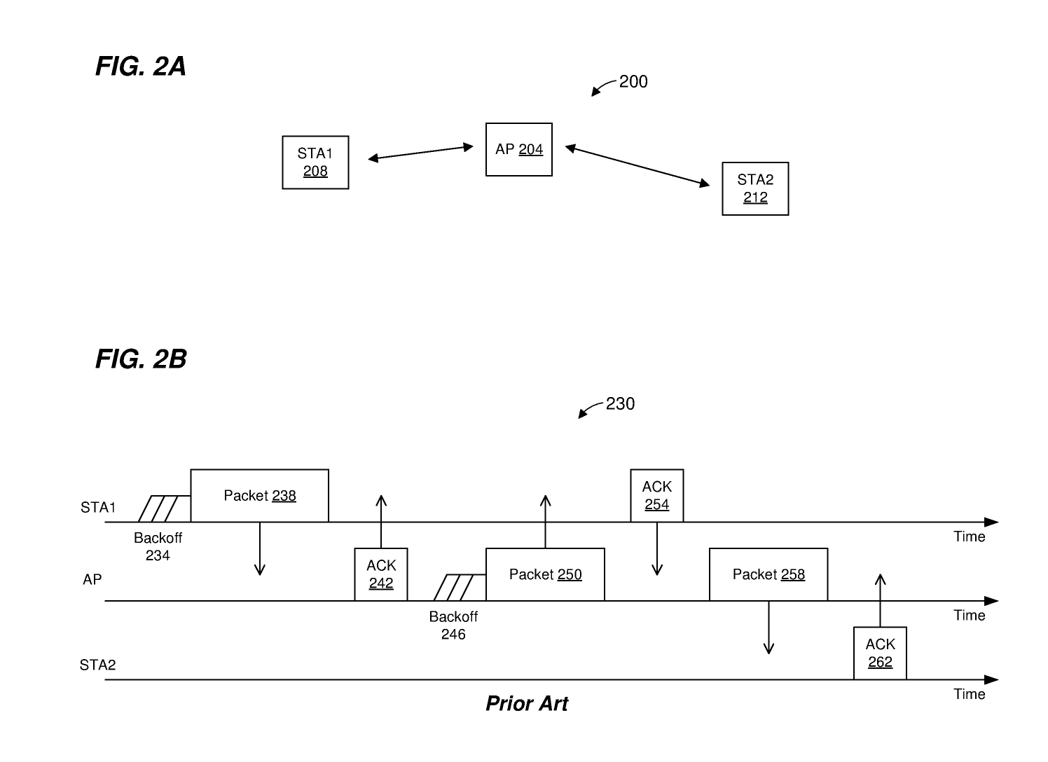

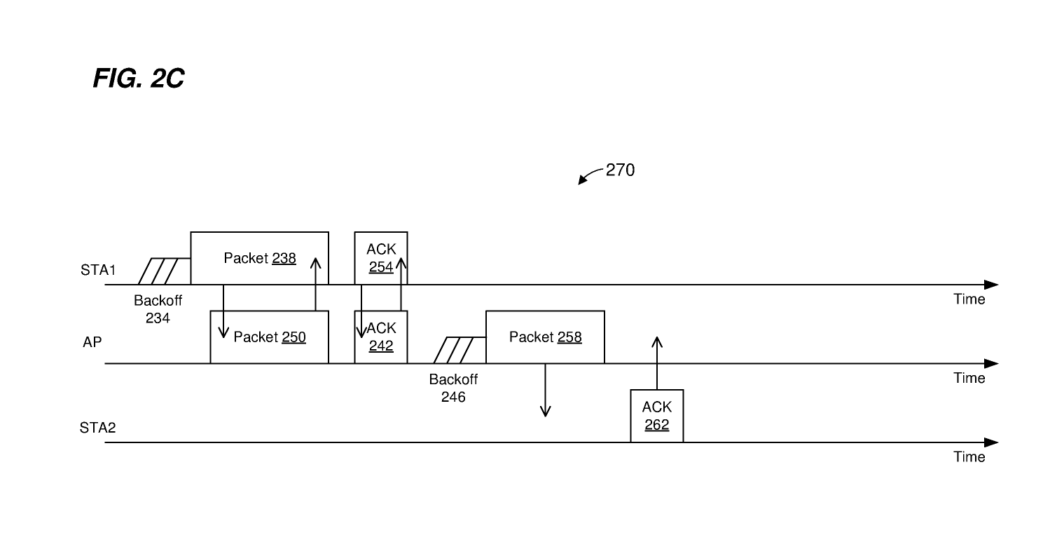

FIG. 2A is a diagram of a spatial arrangement of an example WLAN 200, according to an embodiment. The WLAN 200 includes an AP 204, a client station 208 (STA1), and a client station 212 (STA2). The AP 204 is positioned between the client station 208 and the client station 212 such that a distance between the client station 208 and the client station 212 is relatively far as compared to i) a distance between the AP 204 and the client station 208, and ii) a distance between the AP 204 and the client station 212.

In an embodiment, the AP 204 has the structure of the AP 114 of FIG. 1. In another embodiment, the AP 204 has another suitable structure. In an embodiment, the client station 208 has the structure of the client station 154-1 of FIG. 1. In another embodiment, the client station 208 has another suitable structure. In an embodiment, the client station 212 has the structure of the client station 154-1 of FIG. 1. In another embodiment, the client station 212 has another suitable structure. In an embodiment, the client station 212 is not configured for in-band duplex communication.

FIG. 2B is a timing diagram of an example half-duplex communication exchange 230 in the WLAN 200 of FIG. 2A. The client station 208 performs a backoff operation 234 and then transmits a PHY protocol data unit (PPDU) 238 to the AP 204. In an embodiment, the backoff operation 234 comprises performing a clear channel assessment (CCA) to determine whether the channel is busy.

A suitable time period (e.g., a short interframe space (SIFS) as defined by the IEEE 802.11 Standard or another suitable time period) after an end of the PPDU 238, the AP 204 transmits to the client station 208 a PPDU 242 that includes an acknowledgement (ACK) of the PPDU 238.

Next, the AP 204 performs a backoff operation 246 (e.g., to determine that the channel is not busy) and then transmits a PPDU 250 to the client station 208. A suitable time period (e.g., SIFS or another suitable time period) after an end of the PPDU 250, the client station 208 transmits to the AP 204 a PPDU 254 that includes an ACK of the PPDU 250.

Next, the AP 204 transmits a PPDU 258 to the client station 212. A suitable time period (e.g., SIFS or another suitable time period) after an end of the PPDU 258, the client station 212 transmits to the AP 204 a PPDU 262 that includes an ACK of the PPDU 258.

FIG. 2C is a timing diagram of an example duplex communication exchange 270 in the WLAN 200 of FIG. 2A, according to an embodiment. The same PPDUs transmitting in the communication exchange 230 of FIG. 2B are transmitted in the communication exchange 270 of FIG. 2C, but duplex communication techniques are employed in the communication exchange 270, which results in less time required to complete the communication exchange 270 as compared to the communication exchange 230.

The client station 208 performs the backoff operation 234 (e.g., to determine that a channel is not busy) and then transmits the PPDU 238 to the AP 204. The AP 204 determines that duplex communication to the client station 208 during reception of the PPDU 238 can be performed, and thus transmits the PPDU 250 to the client station 208 simultaneous with reception of the PPDU 238.

A suitable time period (e.g., SIFS or another suitable time period) after an end of the PPDU 238, the AP 204 transmits to the client station. 208 the PPDU 242 which includes an ACK of the PPDU 238. Similarly, a suitable time period (e.g., SIFS or another suitable time period) after an end of the PPDU 250, the client station 208 transmits to the AP 204 the PPDU 254 which includes an ACK of the PPDU 250. The AP 204 transmits the PPDU 242 simultaneous with reception of the PPDU 254, and the client station 208 transmits the PPDU 254 simultaneous with reception of the PPDU 242.

Next, the AP 204 performs the backoff operation 246 (e.g., to determine that the channel is not busy) and then transmits the PPDU 258 to the client station 212. A suitable time period (e.g., SITS or another suitable time period) after an end of the PPDU 258, the client station 212 transmits to the AP 204 the PPDU 262 that includes an ACK of the PPDU 258.

As can be seen when comparing FIGS. 2B and 2C, simultaneous transmission of the PPDUs 238 and 250, and simultaneous transmission of the PPDUs 242 and 254 results in the communication exchange 270 taking considerably less time than the communication exchange 230. Thus, duplex communication techniques can improve overall system efficiency by increasing the amount of information that can be exchanged in a given amount of time.

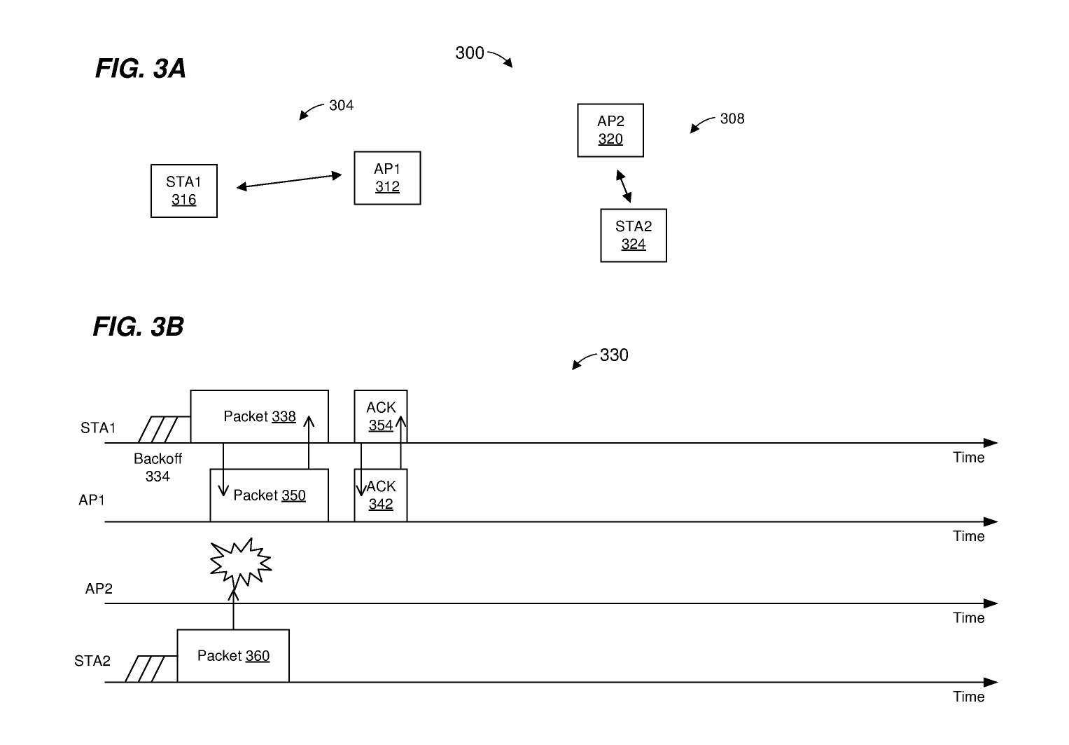

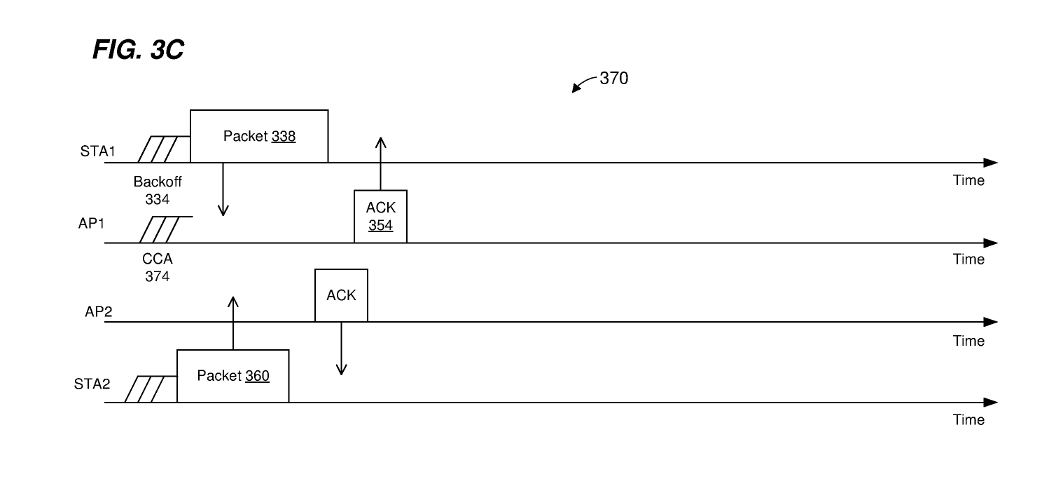

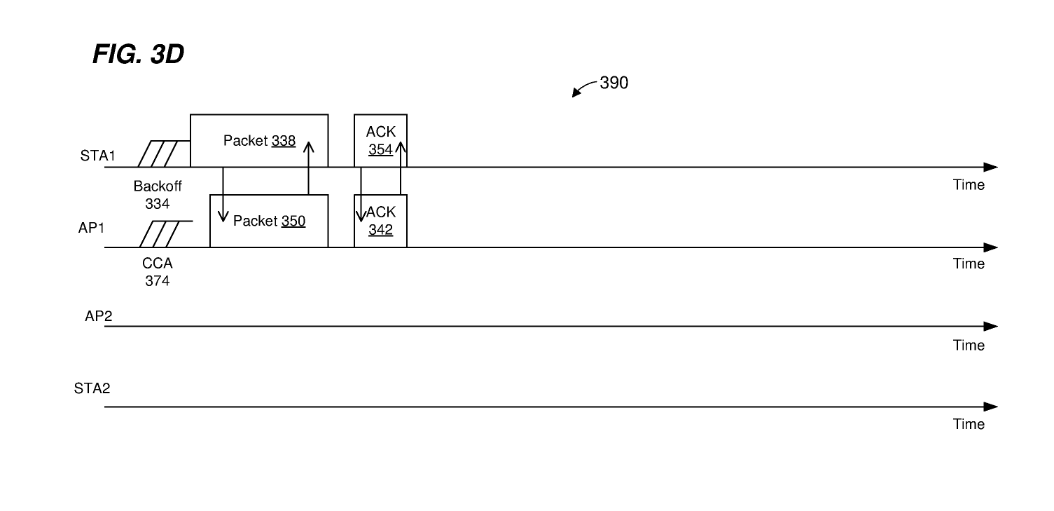

FIG. 3A is a diagram of a spatial arrangement of an example system 300 that comprises a first WLAN 304 and a second WLAN 308, according to an embodiment. The first WLAN 304 includes an AP 312 (AP1) and a client station 316 (STA1). The second WLAN 308 includes an AP 320 (AP2) and a client station 324 (STA2). The AP 312 is positioned between the client station 316 and the second WLAN 308 such that a distance between the client station 316 and the AP 320 is relatively far as compared to i) a distance between the AP 312 and the AP 320, and ii) a distance between the AP 312 and the client station 324.

In an embodiment, the AP 312 has the structure of the AP 114 of FIG. 1. In another embodiment, the AP 312 has another suitable structure.

FIG. 3B is a timing diagram of an example duplex communication exchange 330 in the system 300 of FIG. 3A, according to an embodiment.

The client station 316 performs a backoff operation 334 (e.g., to determine that a channel is not busy) and then transmits the PPDU 338 to the AP 312. The AP 312 determines that duplex communication to the client station 316 during reception of the PPDU 338 can be performed, and thus transmits the PPDU 350 to the client station 316 simultaneous with reception of the PPDU 338. A transmission (such as the PPDU 350) that is performed simultaneously with receiving a packet (e.g., the PPDU 338) is sometimes referred to herein as a “duplex transmission.”

A suitable time period (e.g., SIFS or another suitable time period) after an end of the PPDU 338, the AP 312 transmits to the client station 316 the PPDU 354 which includes an ACK of the PPDU 338. Similarly, a suitable time period (e.g., SIFS or another suitable time period) after an end of the PPDU 350, the client station 316 transmits to the AP 312 the PPDU 354 which includes an ACK of the PPDU 350. The AP 312 transmits the PPDU 342 simultaneous with reception of the PPDU 354, and the client station 316 transmits the PPDU 354 simultaneous with reception of the PPDU 342.

Prior to a start of transmission of the PPDU 338, the client station 324 began transmitting a PPDU 360 to the AP 320. Because of the relatively long distance between the client station 316 and the AP 320, the transmission of the PPDU 338 does not interfere with the reception of the PPDU 360 by the AP 320. However, because of the relatively short distance between the AP 312 and the AP 320, the transmission of the PPDU 350 does interfere with the reception of the PPDU 360 by the AP 320, which prevents the AP 320 from successfully receiving the PPDU 360, e.g., a collision occurs.

FIG. 3C is a timing diagram of an example communication exchange 370 in the system 300 of FIG. 3A, according to an embodiment. Some of same PPDUs transmitting in the communication exchange 330 of FIG. 3B are transmitted in the communication exchange 370 of FIG. 3C, but a CCA technique is employed in the communication exchange 370, which results in the collision in the communication exchange 230 being avoided.

In preparation for performing a duplex transmission to the client station 316 (e.g., such as the transmission of the PPDU 350 illustrated in FIG. 3B), the AP 312 performs a CCA operation 374 to determine whether a channel, which the PPDU 338 spans, is being utilized by another communication network. Due to the transmission of the PPDU 360 by the client station 324, the AP 312 determines, during performance of the CCA operation 374, that the channel is being utilized by another communication network. As a result of determining that the channel is being utilized by another communication network, the AP 312 does not perform the duplex transmission to the client station 316 during the reception of the PPDU 338, and thus the AP 320 successfully receives the PPDU 360.

On the other hand, if the AP 312 had determined, during of the CCA operation 374, that the channel was not being utilized by another communication network, the AP 312 would have transmitted the PPDU 350. For example, FIG. 3D is a timing diagram of an example communication exchange 390 in the system 300 of FIG. 3A, according to an embodiment. In the communication exchange 390, the AP 312 determines, during of the CCA operation 374, that the channel was not being utilized by another communication network, and thus the AP 312 transmits the PPDU 350.

In an embodiment, the CCA operation 374 includes the AP 312 determining whether a network allocation vector (NAV) timer of the AP 312 indicates that another communication network is also using the communication channel during the transmission of the PPDU 338. In an embodiment, a NAV timer (e.g., included in a MAC processor) is a timer that is used for indicating whether a communication channel is in use. In an embodiment, the NAV timer additionally or alternatively is used for indicating whether a communication channel is reserved for use (sometimes referred to as “ownership” of the communication channel) for a particular period of tune (sometimes referred to as a transmit opportunity period (TROP). The communication device that has claimed ownership of the communication channel is sometimes referred to herein as the “TXOP owner” or the “TXOP initiator”, and devices that transmit to the TXOP owner during the TXOP are sometimes referred to herein as “TXOP responders”.

In an embodiment, when the AP 312 receives a PPDU, the AP 312 examines a duration field in a MAC header of the PPDU and uses a value in the duration field to set the NAV timer. The value in the duration field indicates a time period that includes i) a transmission time of the PPDU, and optionally ii) an additional time period, according to some embodiments. For example, the additional time period corresponds to one or more of i) one or more interframe spaces, and/or ii) transmission time(s) of one or more additional packets (e.g., an acknowledgment packet) that follow the PPDU, in some embodiments. If the PPDU includes a request-to-send (RTS) frame or a clear-to-send (CTS) frame, the value in the duration field indicates a duration of a TXOP corresponding to a reserving of the communication channel, according to an embodiment. In an embodiment, the communication device that transmitted the RTS frame is the TXOP owner/TXOP initiator. In some embodiments, a communication device can become a TXOP owner/TXOP initiator by transmitting a CTS-to-self frame, which includes duration field that indicates a duration of the TXOP.

In an embodiment, the NAV timer decrements at a constant rate so that the NAV timer reaches zero when the time period ends. Thus, a non-zero value of the NAV timer indicates that the communication channel is in use (i.e., is busy or “not idle”), whereas a zero value of the NAV timer indicates that the communication channel is not in use (i.e., is idle), according to some embodiments. Using a NAV timer to determine whether the communication channel is in use is sometimes referred to herein as performing a “virtual CCA procedure”. Thus, determining whether another communication network is also using the communication channel during the transmission of the PPDU 338 includes performing a virtual CCA procedure, according to an embodiment. For example, determining whether another communication network is also using the communication channel during the transmission of the PPDU 338 includes determining whether a NAV timer is non-zero, according to an embodiment.

During a TXOP, the TXOP initiator may transmit packets to multiple TXOP responders sequentially. If a TXOP responder sets a NAV timer in response to a packet from the TXOP initiator (e.g., a packet having an RTS frame), the TXOP responder may determine that the communication channel is busy later on during the TXOP because the NAV timer is not zero, thus the TXOP responder cannot participate in a duplex transmission to the TXOP owner. To avoid TXOP responders determining that they cannot participate in a duplex transmission to the TXOP owner during the TXOP because of a non-zero NAV timer, several techniques are described below.

In some embodiments, a network interface device (e.g., a MAC processor), when setting the NAV timer in response to receiving a packet, stores in a memory device (e.g., a register associated with the NAV timer, a location (associated with the NAV timer) in a memory device, etc.) of, or coupled to, the network interface device (e.g., of or coupled to the MAC processor), an indication of whether the NAV was set in connection with a transmission within the communication network (e.g., transmitted by a communication that belongs to the communication network) or within another communication network (e.g., transmitted by a communication device that does not belong to the communication network, e.g., belongs to another communication network). For example, a PHY header of the packet includes a network identifier (ID) (e.g., a basic service set (BSS) color ID, a BSS identifier (BSSID), or another suitable network ID), and the network interface device examines (e.g., the MAC processor examines) the network ID in the PHY header to determine whether the packet was transmitted within the communication network or was transmitted within another communication network, according to an embodiment. As another example, a MAC header of a packet includes a network identifier (ID) (e.g., BSSID, or another suitable network ID), and the network interface device examines (e.g., the MAC processor examines) the network ID in the MAC header to determine whether the packet was transmitted within the communication network or was transmitted within another communication network, according to an embodiment.

In some embodiments in which the MAC processor stores in the memory device the indication of whether the NAV tinier was set in connection with a transmission within the communication network or within another communication network, the virtual CCA procedure includes ignoring the NAV timer if the indication in the memory device indicates that the NAV timer was set in connection with a transmission within the communication network. For example, if the indication in the memory device indicates that the NAV timer was set in connection with a transmission within the communication network, the network interface device (e.g., the MAC processor) does not determine that a non-zero value of the NAV timer indicates that another communication network is also using the communication channel during the transmission of the PPDU 338. In an embodiment, if the indication in the memory device indicates that the NAV timer was set in connection with a transmission within the communication network, the network interface device (e.g., the MAC processor) determines that the virtual CCA procedure indicates that another communication network is not using the communication channel during the transmission of the PPDU 338 even when the NAV timer is non-zero.

In some embodiments, the network interface device (e.g., the MAC processor), when setting the NAV timer in response to receiving a packet, stores in the memory device of, or coupled to, the network interface device (e.g., the MAC processor) an identifier of the transmitter (transmitter ID) of the packet. For example, a header of the packet (e.g., a PHY header, a MAC header, etc.) includes a transmitter ID, and the network interface device stores the transmitter ID in the memory device in connection with setting the NAV timer, according to an embodiment. For instance, a MAC header of the packet includes a transmitter ID (e.g., a MAC address, an association identifier (AID), or another suitable transmitter ID), and the MAC processor stores the transmitter ID (from the MAC header) in the memory device in connection with setting the NAV timer, according to an embodiment.

In some embodiments in which the network interface device stores, in the memory device, the transmitter ID corresponding to the packet that was used to set the NAV, the virtual CCA procedure includes ignoring the NAV timer if the transmitter ID in the memory device indicates that the NAV timer was set in connection with a transmission within the communication network. For example, if the transmitter ID in the memory device is the same as a transmitter ID in a header (e.g., a PHY header, a MAC header) of the PPDU 338, the network interface device does not (e.g., the MAC processor does not) determine that a non-zero value of the NAV timer indicates that another communication network is also using the communication channel during the transmission of the PPDU 338; on the other hand, if the transmitter ID in the memory device is different than the transmitter ID in the header of the PPDU 338, the network interface device determines (e.g., the MAC processor determines) that a non-zero value of the NAV timer indicates that another communication network is also using the communication channel during the transmission of the PPDU 338. In an embodiment, if the transmitter ID (corresponding to the packet that was used to set the NAV) in the memory device is the same as a transmitter ID in a header (e.g., a PHY header, a MAC header) of the PPDU 338, the network interface device (e.g., the MAC processor) determines that the virtual CCA procedure indicates that another communication network is not using the communication channel during the transmission of the PPDU 338 even when the NAV timer is non-zero; on the other hand, if the transmitter ID in the memory device is different than the transmitter ID in the header of the PPDU 338, the network interface device (e.g., the MAC processor) determines that the virtual CCA procedure indicates that another communication network is using the communication channel during the transmission of the PPDU 338 when the NAV timer is non-zero.

In some embodiments, the network interface device (e.g., the MAC processor), maintains multiple NAV timers, e.g., a first NAV timer corresponding to intra-BSS communications (e.g., transmissions within the communication network), and one or more second NAV timers corresponding to inter-BSS communications (e.g., transmissions in one or more other communication networks).

In some embodiments in which the network interface device maintains a first NAV tinier corresponding to intra-BSS communications, and one or more second NAV timers corresponding to inter-BSS communications, the virtual CCA procedure includes ignoring the first NAV timer. For example, the network interface device does not (e.g., the MAC processor does not) determine that another communication network is also using the communication channel during the transmission of the PPDU 338 if the one or more second NAV timers are zero but the first NAV timer is non-zero; on the other hand, the network interface device determines (e.g., the MAC processor determines) that another communication network is also using the communication channel during the transmission of the PPDU 338 if any of the one or more second NAV timers are non-zero even if the first NAV timer zero.

In some scenarios, the network interface device performing a duplex transmission (such as the PPDU 350) simultaneously with receiving a packet (e.g., the PPDU 338) may receive yet another packet while performing the duplex transmission. In some embodiments, the network interface device does not set (e.g., the MAC processor does not set) a NAV timer in response to receiving the other packet even if a duration value in the other packet (e.g., in a PHY header, in a MAC header, etc.) is longer than a current value of the NAV timer. In other embodiments, the network interface device sets (e.g., the MAC processor sets) a NAV timer in response to receiving the other packet if a duration value in the other packet (e.g., in a PHY header, in a MAC header, etc.) is longer than a current value of the NAV timer, at least for some packets. For example, if the other packet is an intra-BSS packet that was transmitted by a TXOP responder, the network interface device does not set (e.g., the MAC processor does not set) the NAV timer even if a duration value in the other packet (e.g., in a PHY header, in a MAC header, etc.) is longer than a current value of the NAV timer; on the other hand, if the other packet is an intra-BSS packet that was transmitted by the TXOP owner, the network interface device sets (e.g., the MAC processor sets) the NAV timer if a duration value in the other packet (e.g., in a PHY header, in a MAC header, etc.) is longer than a current value of the NAV timer.

In some scenarios in which multiple transmissions are occurring simultaneously (such as during duplex transmissions), a network interface device may not be able to decode successfully duration information in a MAC header of a received packet (e.g., the PPDU 338); and thus may not set a NAV timer. In scenarios in which another communication device does not successfully decode duration information in a MAC header of a packet transmitted during a duplex transmission (e.g., the PPDU 338), and thus does not set a NAV timer, the other communication device may also transmit during the duplex transmission and cause a collision. To avoid such collisions, a communication device seeking to participate in duplex transmissions may use an RTS/CTS procedure to establish a TXOP. Additionally or alternatively, a communication device seeking to participate in duplex transmissions may use a CTS-to-self procedure to establish a TXOP. Additionally or alternatively, a PHY header may include a TXOP duration field to indicate a duration of a TXOP, and the communication device seeking to participate in duplex transmissions may populate the TXOP duration field in the PHY header of a packet with duration information to communicate the duration of a TXOP to other communication devices.

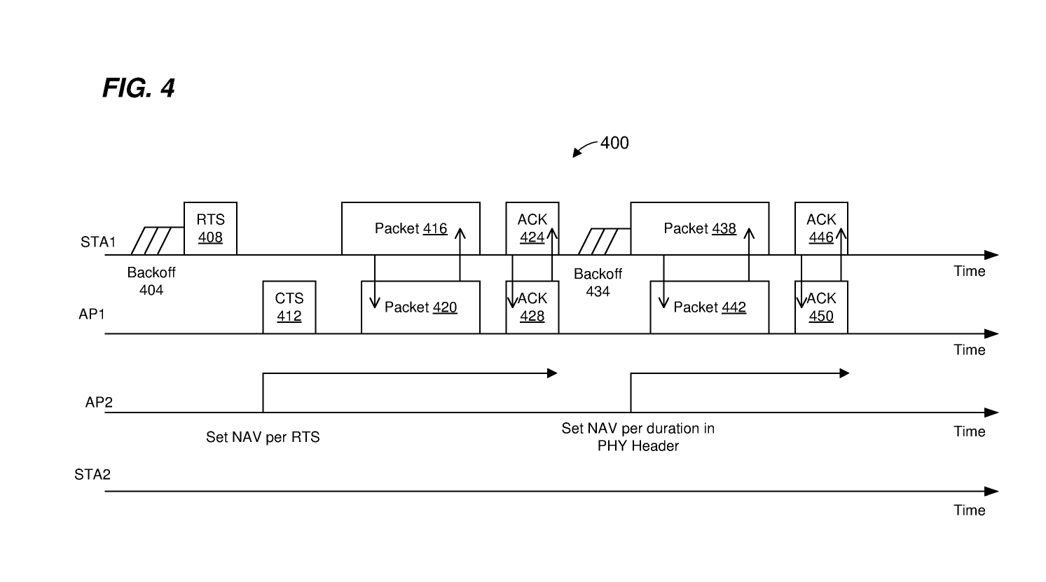

FIG. 4 is a timing diagram of an example communication exchange 400 in the system 300 of FIG. 3A, according to an embodiment. In the communication exchange 400, the client station 316 (STA1) performs a backoff operation 404 (e.g., to determine that a channel is not busy) and then transmits a PPDU 408, which contains an RTS frame, to the AP 312 (AP1). Duration information in the RTS frame indicates a TXOP of a particular duration. The AP 312 determines that that the channel is not busy (from the standpoint of the AP 312) and transmits a PPDU 412, which contains a CTS frame, to the client station 316 (STA1). Duration information in the CTS frame indicates the remaining duration of the TXOP. The AP 320 (AP2) receives the PPDU 408 and sets a NAV timer based on the duration information included in the RTS frame (in the PPDU 408).

The client station 316 transmits a PPDU 416 to the AP 312. The AP 312 determines that a duplex communication to the client station 316 during reception of the PPDU 416 can be performed, and thus transmits a PPDU 420 to the client station 316 simultaneous with reception of the PPDU 416. The AP 320 (AP2) refrains from transmitting during transmission of the PPDU 416 and the PPDU 420 (and subsequent PPDUs 424, 428) because the NAV timer of the AP 320 is non-zero.

Later, during the TXOP or after the TXOP has ended, the client station 316 (STA1) performs a backoff operation 434 (e.g., to determine that the channel is not busy) and then transmits a PPDU 438. Duration information in a PHY header of the PPDU 438 indicates a TXOP of a particular duration. For example, the duration information in the PHY header of the PPDU 438 indicates that the duration of the existing TXOP has been extended, or a new TXOP has a particular duration.

The AP 320 (AP2) receives the PPDU 438 and sets the NAV timer based on the duration information included in the PHY header of the PPDU 438.

The AP 312 determines that a duplex communication to the client station 316 during reception of the PPDU 438 can be performed, and thus transmits a PPDU 442 to the client station 316 simultaneous with reception of the PPDU 438. The AP 320 (AP2) refrains from transmitting during transmission of the PPDU 438 and the PPDU 442 (and subsequent PPDUs 446, 450) because the NAV timer of the AP 320 is non-zero.

In an embodiment, a transmitter of a CTS corresponding to a TXOP is not required to perform a CCA procedure during the TXOP in order to perform a duplex transmission. For example, the AP 312 does not perform a CCA procedure in connection with transmitting the PPDU 430 and/or the PPDU 442.

Referring again to FIGS. 3C and 3D, the CCA operation 374 additionally or alternatively includes a CCA procedure that involve measuring an energy level in the communication channel prior to a beginning of reception of the PPDU 338 and comparing the measured energy level to a threshold (sometimes referred to herein as a “PHY CCA procedure”), according to some embodiments. For example, the PHY processor 126 includes energy measurement circuitry configured to measure the energy level in the communication channel for at least a particular time period (e.g., a time period equal to a short interframe space (SIFS) as defined in the IEEE 802.11 Standard, a point coordination function (PCF) interframe space (PIE) as defined in the IEEE 802.11 Standard, or another suitable time period) immediately prior to the communication device beginning to receive the packet (e.g., the PPM 338). The PHY processor 126 is configured to provide the measured energy level to the MAC processor 126, and the PHY CCA procedure includes: if the measured energy level during the particular time period exceeds the threshold, the network interface device determines (e.g., the MAC processor 126 determined) that the communication channel is in use (e.g., is busy) and that therefore a duplex communication cannot be performed.

PIFS is longer the SIFS, as defined in the IEEE 802.11 Standard). In an embodiment, if the particular time period for the PHY CCA procedure is PIFS, then a TXOP owner/initiator that is seeking to prompt duplex transmissions during a TXOP is required to space packets (not including the space between a data/control/management packet and an ACK packet that is acknowledging the data/control/management packet) by at least PIFS.

In scenarios in which the received packet (during which a duplex transmission potentially is to be performed) spans multiple sub-channels, the energy measurement circuitry in the PHY processor 130 is configured to measure the energy level in each of the multiple sub-channels for at least the particular time period (e.g., SIFS, PIFS, or another suitable time period), and provide the measured energy levels to the MAC processor 130. The PHY CCA procedure involves the network interface device 122 comparing (e.g., the MAC processor 130 comparing) the measured energy level in each of the multiple sub-channels to one or more suitable thresholds. In an embodiment, if the measured energy level in any of the sub-channels during the particular time period exceeds the respective threshold, the communication device determines that the communication channel is in use (e.g., is busy) and that therefore a duplex communication cannot be performed. In other embodiments, however, if the measured energy level(s) in a set of one or more of the sub-channels during the particular time period does not exceed the respective threshold(s), the communication device determines that the set of one or more sub-channels within the communication channel are not in use (e.g., are idle). In an embodiment, if the PHY CCA procedure determines that the set of one or more sub-channels within the communication channel are not in use (e.g., are idle), and if the virtual CCA also determines that the set of one or more sub-channels within the communication channel are not in use (e.g., are idle), the communication device determines that a duplex communication can be performed.

In some embodiments, a frequency bandwidth of the duplex transmission (e.g., the PPDU 350) is equal to a frequency bandwidth of the received packet (e.g., the PPDU 338). In such embodiments, when the received packet (e.g., the PPDU 338) spans multiple sub-channels, if the measured energy level in any of the sub-channels during the particular time period exceeds the respective threshold, the communication device determines that the communication channel is in use (e.g., is busy) and that therefore a duplex communication cannot be performed.

In some embodiments, a frequency bandwidth of the duplex transmission (e.g., the PPDU 350) is permitted to be less than or equal to a frequency bandwidth of the received packet (e.g., the PPDU 338). In such embodiments, if the measured energy level(s) in a first set of one or more of the sub-channels during the particular time period exceeds the respective threshold(s) but the measured energy level(s) in a second set of one or more of the sub-channels during the particular time period does not exceed the respective threshold(s), the communication device determines that the second set of one or more of the sub-channels are not in use (e.g., are idle) and that therefore a duplex communication can be performed (provided that the virtual CCA procedure also indicates that the second set of one or more of the sub-channels are not in use (e.g., are idle)).

In an embodiment in which a communication protocol defines 20 MHz frequency bandwidth sub-channels, permits PPDUs to be transmitted to span two 20 MHz sub-channels (e.g., a 40 MHz composite channel), and defines a primary 20 MHz sub-channel within each 40 MHz composite channel, a duplex transmission is permitted to span the 40 MHz composite channel if both 20 MHz sub-channels are determined to be idle; a duplex transmission is permitted to span the 20 MHz primary sub-channel if the 20 MHz primary sub-channel is determined to be idle; and a duplex transmission is not permitted to span only the 20 MHz non-primary sub-channel even if the 20 MHz non-primary sub-channel is determined to be idle.

In an embodiment in which a communication protocol defines 20 MHz frequency bandwidth sub-channels, permits PPDUs to be transmitted to span four 20 MHz sub-channels (e.g., an 80 MHz composite channel), defines a primary 20 MHz sub-channel within each 80 MHz composite channel, and defines a primary 40 MHz channel within each 80 MHz composite channel, a duplex transmission is permitted to span the 80 MHz composite channel if all 20 MHz sub-channels are determined to be idle; a duplex transmission is permitted to span the 40 MHz primary channel if the 40 MHz primary channel is determined to be idle; a duplex transmission is permitted to span the 20 MHz primary sub-channel if the 20 MHz primary sub-channel is determined to be idle; a duplex transmission is not permitted to span only a 40 MHz non-primary channel even if the 40 MHz non-primary channel is determined to be idle; and a duplex transmission is not permitted to span only any 20 MHz non-primary sub-channel even if the 20 MHz non-primary sub-channel is determined to be idle.

In an embodiment in which a communication protocol defines 20 MHz frequency bandwidth sub-channels, permits PPDUs to be transmitted to span eight 20 MHz sub-channels (e.g., a 160 MHz composite channel (e.g., a contiguous 160 MHz channel, or two separate contiguous 80 MHz channels)), defines a primary 20 MHz sub-channel within each 160 MHz composite channel, defines a primary 40 MHz channel within each 160 MHz composite channel, and defines a primary 80 MHz channel within each 160 MHz composite channel, a duplex transmission is permitted to span the 160 MHz composite channel if all 20 MHz sub-channels are determined to be idle; a duplex transmission is permitted to span the 80 MHz primary channel if all 20 MHz sub-channels within the 80 MHz primary channel are determined to be idle; a duplex transmission is permitted to span the 40 MHz primary channel if the 40 MHz primary channel is determined to be idle; a duplex transmission is permitted to span the 20 MHz primary sub-channel if the 20 MHz primary sub-channel is determined to be idle; a duplex transmission is not permitted to span only a 80 MHz non-primary channel even if the 80 MHz non-primary channel is determined to be idle; a duplex transmission is not permitted to span only a 40 MHz non-primary channel even if the 40 MHz non-primary channel is determined to be idle; and a duplex transmission is not permitted to span only any 20 MHz non-primary sub-channel even if the 20 MHz non-primary sub-channel is determined to be idle.

In an embodiment, the network interface device (e.g., the MAC processor) is configured to perform a backoff operation in connection with transmitting PPDUs. In an embodiment, the backoff operation includes using one or more backoff timers. For example, a backoff operation includes randomly or pseudorandomly choosing an initial value for a backoff timer from a range of initial values. In an embodiment, the range of initial values is [0, CW], where CW is a contention window parameter, where the initial value and CW are in units of a slots, and where each slot corresponds to a suitable time period. For example, the IEEE 802.11 Standard defines slot times of 20 microseconds (IEEE 802.11b) and 9 microseconds (IEEE 802.11a, 11n, and 11ac), where different slot times are used for different versions of the protocol. In an embodiment, CW is initially set to a minimum value CWmin. However, after each failed transmission attempt (e.g., failure to receive an acknowledgment of the transmission), the value of CW is approximately doubled with an upper bound of CWmax. The parameters CWmin and CWmax are also in units of slots.

In some embodiments, the backoff operation also includes using one or more retry counters. A retry counter is a counter used to indicate how many time a communication device has attempted to transmit a MAC data unit. Each time the MAC data unit is transmitted, the retry counter is incremented. In an embodiment, the network interface device maintains (e.g., the MAC processor maintains) a short retry counter for MAC data units that are shorter than a threshold, and a long retry counter for MAC data units that are longer than the threshold.

In an embodiment, a backoff context includes a value of the backoff timer and a value(s) of one or more retry counters. In an embodiment, the network interface device does not update (e.g., the MAC processor does not update) the backoff context in response to transmitting one or more MAC data units in a duplex transmission.

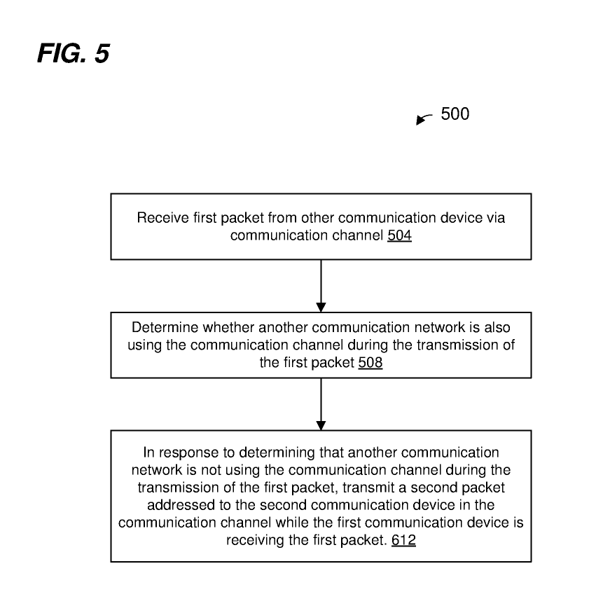

FIG. 5 is a flow diagram of an example method 500 for participating in a duplex transmission, according to an embodiment. In some embodiments, the network interface device 122 of FIG. 1 is configured to implement the method 500. The method 500 is described in the context of the network interface device 122 merely for explanatory purposes and, in other embodiments, the method 500 is implemented by another suitable device. The method 500 is described in the context of FIGS. 3A-3D merely for explanatory purposes. In other embodiments, the method 500 is performed in other suitable communication systems and/or in connection with other suitable transmission exchanges.

At block 504, the network interface device 122 receives a first packet from another communication device. For example, the network interface device 122 of the AP 312 (AP1) receives the PPDU 338 from the client station 316 (STA1). The first packet is addressed to a communication device associated with the network interface device 122, the communication device (associated with the network interface device 122) and the other communication device belong to a communication network, and the first packet spans a communication channel. For example, the AP 312 (AP1) and the client station 316 (STA1) belong to the wireless network 304.

At block 508, the network interface device 122 determines (e.g., the MAC processor 126 determines) whether another communication network is also using the communication channel during the transmission of the first packet. For example, the network interface device 122 performs (e.g., the MAC processor 126 performs) one or both of i) a virtual CCA procedure, and ii) a PHY CCA procedure, according to various embodiments.

In an embodiment, block 508 comprises the network interface device 122 determining (e.g., the MAC processor 126 determining) whether a NAV timer indicates that another communication network is also using the communication channel during the transmission of the first packet. In an embodiment, when the NAV timer indicates that the communication channel is busy and when the NAV timer was set in response to a transmission from a transmitter that belongs to another communication network, block 508 comprises determining that another communication network is using the communication channel during the transmission of the first packet; and when the NAV timer indicates that the communication channel is busy and when the NAV timer was set in response to a transmission from a transmitter that belongs to the communication network, block 508 comprises ignoring the NAV timer.

In an embodiment, when the NAV timer indicates that the communication channel is busy and when the NAV timer was set in response to a transmission from a transmitter other than the second communication device, block 508 comprises determining that another communication network is using the communication channel during the transmission of the first packet; and when the NAV timer indicates that the communication channel is busy and when the NAV timer was set in response to a transmission from the second communication device, block 508 comprises ignoring the NAV timer.

In an embodiment, the NAV timer is a first NAV timer; and the method 500 further comprise maintaining a second NAV timer that indicates whether another communication device in the communication network is using the communication channel; and wherein determining whether another communication network is also using the communication channel during the transmission of the first packet comprises ignoring the second NAV timer.

In an embodiment, block 508 comprises the network interface device 122 measuring (e.g., the PHY processor 130 measuring) energy in the communication channel during a time period immediately prior to a beginning of first packet. In an embodiment, block 508 comprises the network interface device 122 comparing (e.g., the MAC processor 126 comparing) the measured energy in the communication channel during the time period to a threshold.

At block 512, the network interface device 122, in response to determining that another communication network is not using the communication channel during the transmission of the first packet, transmits a second packet addressed to the second communication device. The network interface device 122 transmits the second packet while the first communication device is receiving the first packet. The network interface device 122 transmits the second packet in the communication charnel.

In an embodiment, the first packet and the second packet are transmitted during a TXOP, the communication channel is a first communication channel, and the method 500 further comprises: the network interface device 122 receiving a third packet from the other communication device during the TXOP. In an embodiment, the third packet is addressed to the communication device associated with the network interface device 122, and the third packet is transmitted in a second communication channel. In an embodiment, method 500 further comprises: the network interface device 122 determining (e.g., the MAC processor 126 determining) whether another communication network is also using the second communication channel during the transmission of the third packet; and in response to determining that another communication network is not using the second communication channel during the transmission of the third packet, the network interface device 122 transmits a fourth packet addressed to the second communication device, wherein the fourth packet is transmitted while the first communication device is receiving the third packet

In an embodiment, the communication channel comprises multiple sub-channels; block 508 comprises determining whether another communication network is using any of the multiple sub-channels; and block 512 comprises transmitting the second packet in response to determining that another communication network is not using any of the multiple sub-channels during the transmission of the first packet.

In an embodiment, the communication channel comprises multiple sub-channels; block 508 comprises determining whether another communication network is using each of the multiple sub-channels; block 512 comprises transmitting the second packet is in response to determining that another communication network is using a first subset of the multiple sub-channels and is not using a second subset of the multiple sub-channels during the transmission of the first packet; and the second packet is transmitted in the second subset of the multiple sub-channels and not in the first subset of multiple sub-channels.

### Embodiment 1

A method, comprising: receiving, at a first communication device, a first packet from a second communication device, wherein: the first packet is addressed to the first communication device, the first communication device and the second communication device belong to a communication network, and the first packet spans a communication channel. The method further comprises: determining, at the first communication device, whether another communication network is also using the communication channel during the transmission of the first packet; and in response to determining that another communication network is not using the communication channel during the transmission of the first packet, transmitting, by the first communication device, a second packet addressed to the second communication device, wherein the second packet is transmitted while the first communication device is receiving the first packet, and wherein the second packet is transmitted in the communication channel.

### Embodiment 2

The method of embodiment 1, wherein determining whether another communication network is also using the communication channel during the transmission of the first packet comprises: determining, at the first communication device, whether a network allocation vector (NAV) timer indicates that another communication network is also using the communication channel during the transmission of the first packet.

### Embodiment 3

The method of embodiment 2, wherein determining whether another communication network is also using the communication channel during the transmission of the first packet comprises: when the NAV timer indicates that the communication channel is busy and when the NAV timer was set in response to a transmission from a transmitter that belongs to another communication network, determining that another communication network is using the communication channel during the transmission of the first packet; and when the NAV timer indicates that the communication channel is busy and when the NAV timer was set in response to a transmission from a transmitter that belongs to the communication network, ignoring the NAV timer.

### Embodiment 4

The method of embodiment 2, wherein determining whether another communication network is also using the communication channel during the transmission of the first packet comprises: when the NAV timer indicates that the communication channel is busy and when the NAV timer was set in response to a transmission from a transmitter other than the second communication device, determining that another communication network is using the communication channel during the transmission of the first packet; and when the NAV timer indicates that the communication channel is busy and when the NAV timer was set in response to a transmission from the second communication device, ignoring the NAV timer.

### Embodiment 5

The method of embodiment 2, wherein: the NAV timer is a first NAV timer; the method further comprises: maintaining a second NAV timer that indicates whether another communication device in the communication network is using the communication channel; and wherein determining whether another communication network is also using the communication channel during the transmission of the first packet comprises ignoring the second NAY timer.

### Embodiment 6

The method of any of embodiments 1-5, wherein determining whether another communication network is also using the communication channel during the transmission of the first packet further comprises: measuring, at the first communication device, energy in the communication channel during a tune period immediately prior to a beginning of first packet.

### Embodiment 7

The method of embodiment 6, wherein the first packet and the second packet are transmitted during a transmit opportunity period (TXOP), wherein the communication channel is a first communication channel, and wherein the method further comprises: receiving, at a first communication device, a third packet from the second communication device during the TXOP, wherein: the third packet is addressed to the first communication device, and the third packet is transmitted in a second communication channel. The method also comprises: determining, at the first communication device, whether another communication network is also using the communication channel during the transmission of the third packet; and in response to determining that another communication network is not using the communication channel during the transmission of the third packet, transmitting, by the first communication device, a fourth packet addressed to the second communication device, wherein the fourth packet is transmitted while the first communication device is receiving the third packet.

### Embodiment 8

The method of any of embodiments 1-7, wherein: the communication channel comprises multiple sub-channels; determining whether another communication network is also using the communication channel during the transmission of the first packet comprises determining whether another communication network is using any of the multiple sub-channels; and transmitting the second packet is in response to determining that another communication network is not using any of the multiple sub-channels during the transmission of the first packet.

### Embodiment 9

The method of any of embodiments 1-7, wherein: the communication channel comprises multiple sub-channels; determining whether another communication network is also using the communication channel during the transmission of the first packet comprises determining whether another communication network is using each of the multiple sub-channels; transmitting the second packet is in response to determining that another communication network is using a first subset of the multiple sub-channels and is not using a second subset of the multiple sub-channels during the transmission of the first packet; the second packet is transmitted in the second subset of the multiple sub-channels and not in the first subset of multiple sub-channels.

### Embodiment 10

An apparatus, comprising: a network interface device associated with a first communication device, wherein the network interface device includes one or more integrated circuit (IC) devices. The one or more IC devices are configured to: receive a first packet from a second communication device, wherein: the first packet is addressed to the first communication device, the first communication device and the second communication device belong to a communication network, and the first packet spans a communication channel. The one or more IC devices are further configured to: determine whether another communication network is also using the communication channel during the transmission of the first packet; and in response to determining that another communication network is not using the communication channel during the transmission of the first packet, transmit a second packet addressed to the second communication device, wherein the second packet is transmitted while the first communication device is receiving the first packet, and wherein the second packet is transmitted in the communication channel.

### Embodiment 11

The apparatus of embodiment 10, wherein: the network interface device includes a network allocation vector (NAV) timer implemented on the one or more IC devices; and the one or more IC devices are further configured to: determine whether the NAV timer indicates that another communication network is also using the communication channel during the transmission of the first packet.

### Embodiment 12

The apparatus of embodiment 11, wherein the one or more IC devices are further configured to: when the NAY timer indicates that the communication channel is busy and when the NAV timer was set in response to a transmission from a transmitter that belongs to another communication network, determine that another communication network is using the communication channel during the transmission of the first packet; and when the NAV timer indicates that the communication channel is busy and when the NAV timer was set in response to a transmission from a transmitter that belongs to the communication network, ignore the NAV timer.

### Embodiment 13

The apparatus of embodiment 11, wherein the one or more IC devices are further configured to: when the NAY timer indicates that the communication channel is busy and when the NAV timer was set in response to a transmission from a transmitter other than the second communication device, determine that another communication network is using the communication channel during the transmission of the first packet; and when the NAV timer indicates that the communication channel is busy and when the NAV timer was set in response to a transmission from the second communication device, ignore the NAV timer.

### Embodiment 14

The apparatus of embodiment 11, wherein: the NAV timer is a first NAY timer; the network interface device includes a second NAV timer implemented on the one or more IC devices; the second NAV timer indicates whether another communication device in the communication network is using the communication channel; and the one or more IC devices are further configured to ignore the second NAV timer when determining whether another communication network is also using the communication channel during the transmission of the first packet comprises.

### Embodiment 15

The apparatus of any of embodiments 10-14, wherein: the network interface device comprises energy measurement circuitry implemented on the one more IC devices, the energy measurement circuitry configured to measure energy in the communication channel during a time period immediately prior to a beginning of first packet; the one or more IC devices are further configured to determine whether another communication network is also using the communication channel during the transmission of the first packet using the measured energy in the communication channel during the time period.

### Embodiment 16

The apparatus of embodiment 15, wherein: the first packet and the second packet are transmitted during a transmit opportunity period (TXOP); the communication channel is a first communication channel; the one or more IC devices are further configured to receive a third packet from the second communication device during the TXOP; the third packet is addressed to the first communication device; the third packet is transmitted in a second communication channel; the one or more IC devices are further configured to: determine whether another communication network is also using the communication channel during the transmission of the third packet, and in response to determining that another communication network is not using the communication channel during the transmission of the third packet, transmit a fourth packet addressed to the second communication device; and the fourth packet is transmitted while the first communication device is receiving the third packet.

### Embodiment 17

The apparatus of any of embodiments 10-16, wherein: the communication channel comprises multiple sub-channels; the one or more IC devices are further configured to: determine whether another communication network is using any of the multiple sub-channels, and transmit the second packet is in response to determining that another communication network is not using any of the multiple sub-channels during the transmission of the first packet.

### Embodiment 18

The apparatus of any of embodiments 10-16, wherein: the communication channel comprises multiple sub-channels; the one or more IC devices are further configured to: determine whether another communication network is using each of the multiple sub-channels, and transmit the second packet in response to determining that another communication network is using a first subset of the multiple sub-channels and is not using a second subset of the multiple sub-channels during the transmission of the first packet; and the second packet is transmitted in the second subset of the multiple sub-channels and not in the first subset of multiple sub-channels.

### Embodiment 19

The apparatus of any of embodiments 10-18, wherein: the network interface device comprises i) a media access control (MAC) processor implemented on the one or more IC devices, and ii) a physical layer (PHY) processor implemented on the one or more IC devices, and coupled to the MAC processor; and the MAC processor is configured to: determine whether another communication network is also using the communication channel during the transmission of the first packet, and in response to determining that another communication network is not using the communication channel during the transmission of the first packet, prompt the PHY processor to transmit the second packet while the first communication device is receiving the first packet.

### Embodiment 20

The apparatus of embodiment 19, further comprising: one or more antennas coupled to the network interface device.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A method, comprising:
receiving, at a first communication device, a first packet from a second communication device, wherein:
the first packet is addressed to the first communication device,
the first communication device and the second communication device belong to a communication network, and
the first packet spans a communication channel;
determining, at the first communication device, whether another communication network is also using the communication channel during the transmission of the first packet; and
in response to determining that another communication network is not using the communication channel during the transmission of the first packet, transmitting, by the first communication device, a second packet addressed to the second communication device, wherein the second packet is transmitted while the first communication device is receiving the first packet, and wherein the second packet is transmitted in the communication channel.

2. The method of claim 1, wherein determining whether another communication network is also using the communication channel during the transmission of the first packet comprises:
determining, at the first communication device, whether a network allocation vector (NAV) timer indicates that another communication network is also using the communication channel during the transmission of the first packet.

3. The method of claim 2, wherein determining whether another communication network is also using the communication channel during the transmission of the first packet comprises:
when the NAV timer indicates that the communication channel is busy and when the NAV timer was set in response to a transmission from a transmitter that belongs to another communication network, determining that another communication network is using the communication channel during the transmission of the first packet; and
when the NAV timer indicates that the communication channel is busy and when the NAV timer was set in response to a transmission from a transmitter that belongs to the communication network, ignoring the NAV timer.

4. The method of claim 2, wherein determining whether another communication network is also using the communication channel during the transmission of the first packet comprises:
when the NAV timer indicates that the communication channel is busy and when the NAY timer was set in response to a transmission from a transmitter other than the second communication device, determining that another communication network is using the communication channel during the transmission of the first packet; and
when the NAV timer indicates that the communication channel is busy and when the NAV timer was set in response to a transmission from the second communication device, ignoring the NAV timer.

5. The method of claim 2, wherein:
the NAV timer is a first NAV timer,
the method further comprises: maintaining a second NAY timer that indicates whether another communication device in the communication network is using the communication channel; and
wherein determining whether another communication network is also using the communication channel during the transmission of the first packet comprises ignoring the second NAY timer.

6. The method of claim 1, wherein determining whether another communication network is also using the communication channel during the transmission of the first packet further comprises:
measuring, at the first communication device, energy in the communication channel during a time period immediately prior to a beginning of first packet.

7. The method of claim 6, wherein the first packet and the second packet are transmitted during a transmit opportunity period (TXOP), wherein the communication channel is a first communication channel, and wherein the method further comprises:
receiving, at a first communication device, a third packet from the second communication device during the TXOP, wherein:
the third packet is addressed to the first communication device, and
the third packet is transmitted in a second communication channel;
determining, at the first communication device, whether another communication network is also using the communication channel during the transmission of the third packet; and
in response to determining that another communication network is not using the communication channel during the transmission of the third packet, transmitting, by the first communication device, a fourth packet addressed to the second communication device, wherein the fourth packet is transmitted while the first communication device is receiving the third packet.

8. The method of claim 1, wherein:
the communication channel comprises multiple sub-channels;
determining whether another communication network is also using the communication channel during the transmission of the first packet comprises determining whether another communication network is using any of the multiple sub-channels; and
transmitting the second packet is in response to determining that another communication network is not using any of the multiple sub-channels during the transmission of the first packet.

9. The method of claim 1, wherein:
the communication channel comprises multiple sub-channels;
determining whether another communication network is also using the communication channel during the transmission of the first packet comprises determining whether another communication network is using each of the multiple sub-channels;
transmitting the second packet is in response to determining that another communication network is using a first subset of the multiple sub-channels and is not using a second subset of the multiple sub-channels during the transmission of the first packet;
the second packet is transmitted in the second subset of the multiple sub-channels and not in the first subset of multiple sub-channels.

10. An apparatus, comprising:
a network interface device associated with a first communication device, wherein the network interface device includes one or more integrated circuit (IC) devices configured to:
receive a first packet from a second communication device, wherein:
the first packet is addressed to the first communication device,
the first communication device and the second communication device belong to a communication network, and
the first packet spans a communication channel;
wherein the one or more IC devices are further configured to:
determine whether another communication network is also using the communication channel during the transmission of the first packet, and
in response to determining that another communication network is not using the communication channel during the transmission of the first packet, transmit a second packet addressed to the second communication device, wherein the second packet is transmitted while the first communication device is receiving the first packet, and wherein the second packet is transmitted in the communication channel.

11. The apparatus of claim 10, wherein:
the network interface device includes a network allocation vector (NAV) timer implemented on the one or more IC devices; and
the one or more IC devices are further configured to: determine whether the NAY timer indicates that another communication network is also using the communication channel during the transmission of the first packet.

12. The apparatus of claim 11, wherein the one or more IC devices are further configured to:
when the NAV timer indicates that the communication channel is busy and when the NAV timer was set in response to a transmission from a transmitter that belongs to another communication network, determine that another communication network is using the communication channel during the transmission of the first packet; and
when the NAV timer indicates that the communication channel is busy and when the NAV timer was set in response to a transmission from a transmitter that belongs to the communication network, ignore the NAV timer.

13. The apparatus of claim 11, wherein the one or more IC devices are further configured to:
when the NAV timer indicates that the communication channel is busy and when the NAV timer was set in response to a transmission from a transmitter other than the second communication device, determine that another communication network is using the communication channel during the transmission of the first packet; and
when the NAV timer indicates that the communication channel is busy and when the NAV timer was set in response to a transmission from the second communication device, ignore the NAV timer.

14. The apparatus of claim 11, wherein:
the NAV timer is a first NAV timer;
the network interface device includes a second NAV timer implemented on the one or more IC devices;
the second NAY timer indicates whether another communication device in the communication network is using the communication channel; and
the one or more IC devices are further configured to ignore the second NAY timer when determining whether another communication network is also using the communication channel during the transmission of the first packet comprises.

15. The apparatus of claim 10, wherein:
the network interface device comprises energy measurement circuitry implemented on the one more IC devices, the energy measurement circuitry configured to measure energy in the communication channel during a time period immediately prior to a beginning of first packet;
the one or more IC devices are further configured to determine whether another communication network is also using the communication channel during the transmission of the first packet using the measured energy in the communication channel during the time period.

16. The apparatus of claim 15, wherein:
the first packet and the second packet are transmitted during a transmit opportunity period (TXOP);
the communication channel is a first communication channel;
the one or more IC devices are further configured to receive a third packet from the second communication device during the TXOP;
the third packet is addressed to the first communication device;
the third packet is transmitted in a second communication channel;
the one or more IC devices are further configured to:
determine whether another communication network is also using the communication channel during the transmission of the third packet, and
in response to determining that another communication network is not using the communication channel during the transmission of the third packet, transmit a fourth packet addressed to the second communication device; and
the fourth packet is transmitted while the first communication device is receiving the third packet.

17. The apparatus of claim 10, wherein:
the communication channel comprises multiple sub-channels;
the one or more IC devices are further configured to:
determine whether another communication network is using any of the multiple sub-channels, and
transmit the second packet is in response to determining that another communication network is not using any of the multiple sub-channels during the transmission of the first packet.

18. The apparatus of claim 10, wherein:
the communication channel comprises multiple sub-channels;
the one or more IC devices are further configured to:
determine whether another communication network is using each of the multiple sub-channels, and
transmit the second packet in response to determining that another communication network is using a first subset of the multiple sub-channels and is not using a second subset of the multiple sub-channels during the transmission of the first packet; and
the second packet is transmitted in the second subset of the multiple sub-channels and not in the first subset of multiple sub-channels.

19. The apparatus of claim 10, wherein:
the network interface device comprises i) a media access control (MAC) processor implemented on the one or more IC devices, and ii) a physical layer (PHY) processor implemented on the one or more IC devices, and coupled to the MAC processor; and
the MAC processor is configured to:
determine whether another communication network is also using the communication channel during the transmission of the first packet, and
in response to determining that another communication network is not using the communication channel during the transmission of the first packet, prompt the PHY processor to transmit the second packet while the first communication device is receiving the first packet.

20. The apparatus of claim 19, further comprising:
one or more antennas coupled to the network interface device.
